(19) United States
(12) Patent Application Publication
(10) Pub. No.: US 2023/0195921 A1
(43) Pub. Date: Jun. 22, 2023

(54) SYSTEMS AND METHODS FOR DYNAMIC K-ANONYMIZATION

(71) Applicant: Palantir Technologies Inc., Denver, CO (US)

(72) Inventors: Alice Yu, Denver, CO (US); David Herrero-Quevedo, London (GB); David Zhao, Alexandria, VA (US); Mark Bissell, Medfield, MA (US); Yeong Wei Wee, Singapore (SG)

(21) Appl. No.: 18/080,867

(22) Filed: Dec. 14, 2022

Related U.S. Application Data
(60) Provisional application No. 63/290,328, filed on Dec. 16, 2021.

(51) Int. Cl. G06F 21/62

(52) U.S. Cl. CPC G06F 21/6218

(57) ABSTRACT

System and method for k-anonymization with a target k-value according to certain embodiments. For example, a method includes: receiving an input dataset; receiving a k-value, the k-value being a positive integer; receiving one or more quasi-identifiers corresponding to one or more data fields in the input dataset; receiving a data suppression strategy including one or more transformation steps, at least one transformation step of the one or more transformation steps associated with at least one quasi-identifier of one or more one or more quasi-identifiers; and applying the one or more transformation steps to the input dataset to generate a suppressed dataset including at least one suppressed data field corresponding to the at least one data field; checking an anonymity value of each data record of a plurality of data records in the suppressed dataset; selecting a subset of the suppressed dataset from the suppressed dataset.

### CROSS REFERENCE TO RELATED APPLICATIONS

This application claims priority to U.S. Provisional Application No. 63/290,328, filed Dec. 16, 2021, incorporated by reference herein for all purposes.

### TECHNICAL FIELD

Certain embodiments of the present disclosure are directed to systems and methods for data anonymization. More particularly, some embodiments of the present disclosure provide systems and methods for data suppression and/or masking.

### BACKGROUND

Large amount of data has become available for analysis and supporting decision-making. Privacy has been concerns to the public and various laws have been set to address the privacy concerns and regulate the use of data. In some instances, sensitive data that is not personal identifiable by itself may need to be protected, for example, suppressed, as it can be used to identify a person.

Hence it is desirable to improve the techniques for data anonymization, data suppression, and/or data masking.

### SUMMARY

Certain embodiments of the present disclosure are directed to systems and methods for data anonymization. More particularly, some embodiments of the present disclosure provide systems and methods for data suppression and/or masking.

In some embodiments, a method for k-anonymization, the method comprising: receiving an input dataset; receiving a k-value, the k-value being a positive integer; receiving one or more quasi-identifiers corresponding to one or more data fields in the input dataset; receiving a data suppression strategy including one or more transformation steps, at least one transformation step of the one or more transformation steps associated with at least one quasi-identifier of one or more one or more quasi-identifiers; and applying a first transformation step of the one or more transformation steps to at least one data field of the one or more data fields in the input dataset to generate a suppressed dataset including at least one suppressed data field corresponding to the at least one data field; checking an anonymity value of each data record of a plurality of data records in the suppressed dataset; selecting a subset of the suppressed dataset from the suppressed dataset, one or more data records in the selected subset of the suppressed dataset each has a corresponding anonymity value lower than the k-value; and applying a second transformation step of the one or more transformation steps to at least the subset of the suppressed dataset to generate an output, the second transformation step being different from the first transformation step; wherein the method is performed using one or more processors.

In certain embodiments, a method for k-anonymization, the method comprising: receiving an input dataset; receiving a k-value, the k-value being a positive integer; receiving one or more quasi-identifiers; receiving a data suppression strategy including one or more transformation steps, at least one transformation step of the one or more transformation steps associated with at least one quasi-identifier of one or more one or more quasi-identifiers, one transformation step of the one or more transformation steps configured to suppress one or more cells selected from a plurality of cells for a data field in the input dataset, the one or more selected cells being a subset of the plurality of cells; and applying the one or more transformation steps to the input dataset to generate a suppressed dataset such that the suppressed dataset has an anonymity value not lower than the k-value; wherein the method is performed using one or more processors.

In some embodiments, a system for k-anonymization, the system comprising: one or more memories comprising instructions stored thereon; and one or more processors configured to execute the instructions and perform operations comprising: receiving an input dataset; receiving a k-value, the k-value being a positive integer; receiving one or more quasi-identifiers corresponding to one or more data fields in the input dataset; receiving a data suppression strategy including one or more transformation steps, at least one transformation step of the one or more transformation steps associated with at least one quasi-identifier of one or more one or more quasi-identifiers; and applying a first transformation step of the one or more transformation steps to at least one data field of the one or more data fields in the input dataset to generate a suppressed dataset including at least one suppressed data field corresponding to the at least one data field; checking an anonymity value of each data record of a plurality of data records in the suppressed dataset; selecting a subset of the suppressed dataset from the suppressed dataset, one or more data records in the selected subset of the suppressed dataset each has a corresponding anonymity value lower than the k-value; and applying a second transformation step of the one or more transformation steps to at least the subset of the suppressed dataset to generate an output, the second transformation step being different from the first transformation step.

Depending upon embodiments, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a method for k-anonymization and verification according to certain embodiments of the present disclosure.

FIG. 2 is a simplified diagram showing a method for k-anonymization and verification according to certain embodiments of the present disclosure.

FIG. 3 is an illustrative implementation of a k-anonymization process according to certain embodiments of the present disclosure.

FIG. 4 is an illustrative implementation of a k-anonymity-check process according to certain embodiments of the present disclosure.

FIGS. 5-9 are illustrative user interfaces for a k-anonymization system according to certain embodiments of the present disclosure.

FIG. 10 shows an illustrative example of a k-anonymized dataset according to certain embodiments of the present disclosure.

FIG. 11 shows an illustrative example of a k-anonymized dataset and corresponding anonymity values according to certain embodiments of the present disclosure.

FIG. 12 shows an illustrative example of a verification set of suppressed data according to certain embodiments of the present disclosure.

FIG. 13 shows an illustrative example of metadata according to certain embodiments of the present disclosure.

FIG. 14 shows an illustrative example of an anonymized dataset according to certain embodiments of the present disclosure.

FIG. 15 is an illustrative example of a user interface allowing a user to specify a data suppression strategy according to certain embodiments of the present disclosure.

FIG. 16 shows an illustrative example of a suppressed dataset according to certain embodiments of the present disclosure.

FIG. 17 is an illustrative example of a user interface allowing an inspection of suppression strategies for optimizations on suppression order and/or strategies according to certain embodiments of the present disclosure.

FIGS. 18-20 show illustrative examples of a statistics summary of the suppressed data for an inspection of suppression strategies for optimizations on suppression order and/or strategies according to certain embodiments of the present disclosure.

FIG. 21 is an illustrative implementation of a k-anonymization system according to certain embodiments of the present disclosure.

FIG. 22 is a simplified diagram showing a method for k-anonymization and optimization according to certain embodiments of the present disclosure.

FIG. 23 is a simplified diagram showing a computing system for implementing a system for k-anonymization and verification in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about” according to some embodiments. Accordingly, for example, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein according to certain embodiments. However, some embodiments may require certain steps and/or certain orders between certain steps, as may be explicitly described herein and/or as may be understood from the nature of the steps themselves (e.g., the performance of some steps may depend on the outcome of a previous step). Additionally, for example, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input according to some embodiments. As an example, predicting an outcome based on a particular piece of information may additionally, or alternatively, base the same determination on another piece of information. As used herein, for example, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to some embodiments, a k-anonymization system implements and/or optimizes a k-anonymization process to generate suppressed data, for example, to reduce the risk of reidentification of the suppressed data by ensuring there are at least k records with the same quasi-identifying columns in the suppressed data. In certain embodiments, quasi-identifying means attributes not identifying but can be linked with other data (e.g., external data) to uniquely identify an individual. In some embodiments, a quasi-identifier refers to a data field that is not a unique identifier (e.g., government-issued identifier, social security number, etc.) but can be linked with other data fields (e.g., other quasi-identifiers) and/or other data (e.g., external data) to uniquely identify an individual. In certain embodiments, a quasi-identifier does not uniquely identify a person by itself.

According to certain embodiments, organizations often leverage certain data management software for their most sensitive data. In some embodiments, depending on the one or more restrictions on how the data can be used or which users can access it, the data needs to be deidentified, aggregated, k-anonymized, or suppressed in order to be shared. Some existing systems may perform data anonymization manually, often handled in a data transformation process without automated checks or built-in tooling to implement this process in a robust way or on the fly. In some embodiments, k-anonymization, or referred to as data suppression, refers to the process of pooling, bucketing, masking, withholding, or removing selected information in order to protect the identities, privacy, and personal information of individuals in the dataset. In certain examples, a processing of bucketing (e.g., a process of generalization, a process of categorization) includes a process of replacing a piece of data (e.g., 27) by a data range (e.g., 25-35). In some examples, the process of bucketing is associated with a bucket size (e.g., a bucket of 5, a bucket of 10). In some examples, a process of pooling includes a process of replacing a piece of data by a data characteristic (e.g., a mean of a dataset, a medium of a dataset, 29). In certain examples, a process of masking includes a process of masking a portion or all of data in a data field (e.g., masking the last 2 digits of 5 digit zip code, such as masking the zip code of 55543 as 555xx and masking the zip code of 21032 as 210xx).

In some examples, k-anonymization is relevant (e.g., particularly relevant) as one or more studies have shown that a high percentage (e.g., 87%) of the US population is uniquely identified by date-of-birth (DOB), gender, and postcode. In certain examples, K-anonymization is relevant also because in some previous instances, researchers were able to reidentify anonymized one or more movie, TV, and other content ratings by matching one or more rankings and timestamps with movie, TV, and content database.

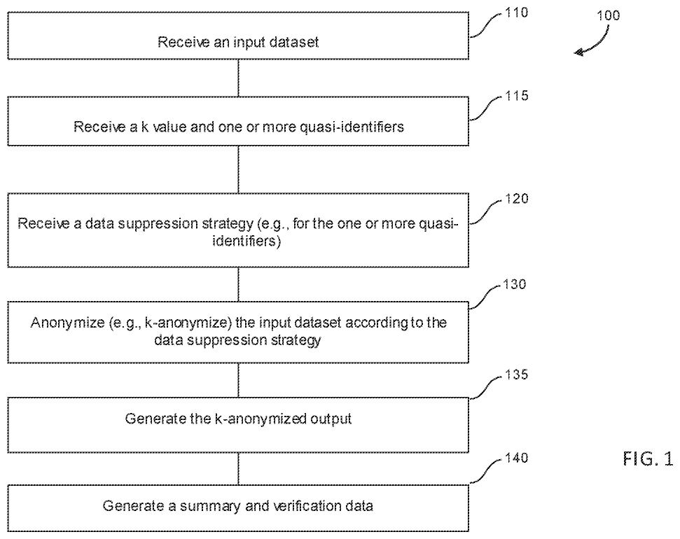

FIG. 1 is a simplified diagram showing a method 100 for k-anonymization and verification according to certain embodiments of the present disclosure. This diagram is merely an example. One of ordinary skill in the art would recognize many variations, alternatives, and modifications. The method 100 for k-anonymization and verification includes processes 110, 115, 120, 130, 135, and 140. Although the above has been shown using a selected group of processes for the method 100 for k-anonymization and verification, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present disclosure.

In some embodiments, some or all processes (e.g., steps) of the method 100 are performed by a system (e.g., the computing system 2300). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 110, the k-anonymization system is configured to receive an input dataset. In certain examples, the input dataset is submitted by and/or received from a user. In some examples, the input dataset is received via a software interface (e.g., application programming interface, web service, etc.) from a computing device and/or a processing system. In certain examples, the input dataset is retrieved from a data repository (e.g., a database, a data file, a data stream, etc.).

According to certain embodiments, at the process 115, the system is configured to receive the target k-value (e.g., k=10) and one or more quasi-identifiers (e.g., age, DOB, postcode, demographic data). In some embodiments, one or more quasi-identifiers include one or more attributes that can be linked with other data (e.g., external data) to uniquely identify an individual. In certain embodiments, a target k-value refers to the number set in a k-anonymization process such that every record (e.g., every row, every data entry, every instance) of the dataset (e.g., a set of records) cannot be distinguished from k-1 or more other records in quasi-identifiers (e.g., k or more records include same quasi-identifiers).

According to some embodiments, at the process 120, the system is configured to receive a data suppression strategy (e.g., for the one or more quasi-identifiers). In certain embodiments, the system is configured to generate a data suppression strategy based on the received one or more quasi-identifiers and the target k-value. In some examples, the data suppression strategy includes suppression transforms (e.g., masking, bucketing, replacing, etc.) for corresponding data columns. In certain examples, the data suppression strategy includes one or more transformation steps, where each transformation step is applied to a specific column or data element. For example, the data suppression strategy includes replacing gender, bucketing ages, and masking zip-code. In certain examples, the data suppression strategy is submitted by and/or received from a user. In some examples, the data suppression strategy is received via a software interface (e.g., application programming interface, web service, etc.) from a computing device and/or a processing system. In certain examples, the data suppression strategy is retrieved from a data repository (e.g., a database, a data file, a configuration file, etc.).

According to certain embodiments, at the process 130, the system is configured to anonymize (e.g., k-anonymize) the input dataset according to the received data suppression strategy to generate a suppressed dataset. For example, the system is configured to bucket ages by 10, replacing genders by “XXXXX”, and masking the last two digits of zip codes by “xx”.

According to some embodiments, at the process 135, the system is configured to generate the k-anonymized output. In certain embodiments, the k-anonymized output includes the suppressed dataset. According to certain embodiments, at the process 140, the system is configured to generate a summary (e.g., a summary of the input data, a summary of the suppressed data, etc.) and verification data. In some examples, the verification data includes a verification set of data rows, where each row includes the raw data (e.g., age) and the suppressed data (e.g., bucketed age).

According to certain embodiments, a summary of the k-anonymization process includes a statistics summary of the suppressed dataset, a statistics summary of the input dataset, a data profile of the suppressed dataset, a data profile of the input dataset, and/or other summary information.

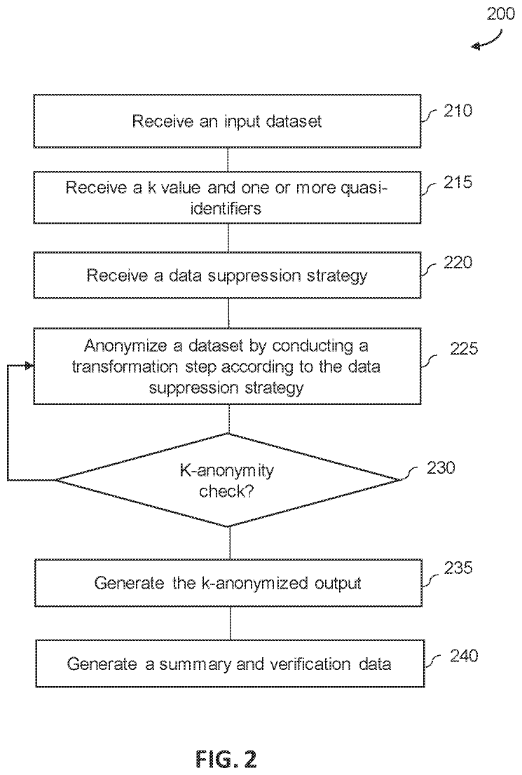

FIG. 2 is a simplified diagram showing a method 200 for k-anonymization and verification according to certain embodiments of the present disclosure. This diagram is merely an example. One of ordinary skill in the art would recognize many variations, alternatives, and modifications. The method 200 for k-anonymization and verification includes processes 210, 215, 220, 225, 230, 235, and 240. Although the above has been shown using a selected group of processes for the method 200 for k-anonymization and verification, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present disclosure.

In some embodiments, some or all processes (e.g., steps) of the method 200 are performed by a system (e.g., the computing system 2300). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 210, the k-anonymization system is configured to receive an input dataset. In certain examples, the input dataset is submitted by and/or received from a user. In some examples, the input dataset is received via a software interface (e.g., application programming interface, web service, etc.) from a computing device and/or a processing system. In certain examples, the input dataset is retrieved from a data repository (e.g., a database, a data file, a data stream, etc.).

According to certain embodiments, at the process 215, the system is configured to receive the target k-value (e.g., k=10) and one or more quasi-identifiers (e.g., demographic data). In some embodiments, one or more quasi-identifiers include one or more attributes that can be linked with external data to uniquely identify an individual. In certain embodiments, a target k-value refers to the number set in a k-anonymization process such that every record (e.g., every row, every data entry, every instance) of the dataset (e.g., a set of records) cannot be distinguished from k-1 or more other records in quasi-identifiers (e.g., k or more records include same quasi-identifiers).

According to some embodiments, at the process 220, the system is configured to receive a data suppression strategy. In some examples, the data suppression strategy includes suppression transforms (e.g., masking, bucketing, replacing, etc.) for corresponding data columns. In certain examples, the data suppression strategy includes one or more transformation steps, where each transformation step is applied to a specific column or data element. For example, the data suppression strategy includes replacing gender, bucketing ages, and masking zip-code. In certain examples, the data suppression strategy is submitted by and/or received from a user. In some examples, the data suppression strategy is received via a software interface (e.g., application programming interface, web service, etc.) from a computing device and/or a processing system. In certain examples, the data suppression strategy is retrieved from a data repository (e.g., a database, a data file, a configuration file, etc.).

According to certain embodiments, at the process 225, the system is configured to anonymize a dataset (e.g., the input dataset, a subsequent input dataset, a subset of suppressed dataset) by conducting a transformation step according to the received data suppression strategy to generate a suppressed dataset. For example, the system is configured to bucket ages by 10, replacing genders by “XXXXX”, and masking the last two digits of zip codes by “xx”.

In some embodiments, an anonymity value (e.g., a degree of anonymity) for a data entry (e.g., a data record, a data row, etc.) refers to the number of data entries (e.g., 1, 5, 25) in a dataset including same quasi-identifiers (e.g., data in quasi-identifier columns, sensitive attributes) as the data entry. In certain embodiments, a k-check, or referred to as a k-anonymity check or an anonymization check, refers to a check to the anonymity value of a data record (e.g., a data entry) in a dataset.

According to certain embodiments, at the process 230, the system is configured to conduct k-anonymity check to the suppressed dataset (e.g., an output dataset) after every step in the data suppression strategy. In some examples, the system is configured to select a subset of the suppressed dataset with anonymity values lower than the target k-value. In some embodiments, the system goes back to the process 225 to anonymize the subset of the suppressed dataset (e.g., a dataset referred to in the process 225) with anonymity values lower than the target k-value by conducting a next transformation step according to the data suppression strategy. In certain embodiments, the system is configured to go to the process 235 after all data entries in the suppressed dataset each having an anonymity value greater than or equal to the target k-value. In some embodiments, the system is configured to go to the process 235 after all transformation steps in the data suppression strategy are conducted.

According to some embodiments, at the process 235, the system is configured to generate the k-anonymized output. In certain embodiments, the k-anonymized output includes the suppressed dataset. According to certain embodiments, at the process 240, the system is configured to generate a summary (e.g., a summary of the input data, a summary of the suppressed data, etc.) and verification data. In some examples, the verification data includes a verification set of data rows, where each row includes the raw data (e.g., age) and the suppressed data (e.g., bucketed age).

According to certain embodiments, a summary of the k-anonymization process includes a statistics summary of the suppressed dataset, a statistics summary of the input dataset, a data profile of the suppressed dataset, a data profile of the input dataset, and/or other summary information.

According to some embodiments, one or more quasi-identifiers include one or more attributes that can be linked with other quasi-identifiers and/or external data to uniquely identify an individual. Examples of quasi-identifiers include, for example, demographics data (e.g., age, gender, etc.).

According to certain embodiments, k, or referred to as k-value or target k-value, refers to the number set in k-anonymization such that every record (e.g., every row, every data entry, every instance) of the dataset (e.g., a set of records) cannot be distinguished from k-1 or more other records in quasi-identifiers (e.g., k or more records include same quasi-identifiers). In some embodiments, an anonymity value for a record refers to the number of records (e.g., 1 record, 5 records, 25 records) in a dataset including same quasi-identifiers as the record. In certain embodiments, a k-check, or referred to as a k-anonymity check or an anonymization check, refers to a check to the anonymity value of each record of a part of or all records in a dataset.

According to some embodiments, strategies for suppressions refer to the type of obfuscation and/or data suppression method to be applied for a specific column or element in a table (e.g., drop the last 2 digits of zip codes, bucket ages).

According to certain embodiments, k-anonymization is a privacy technique used to reduce the risk of reidentification of sensitive data, even after the personal identifiable information (PII) has been removed. In some embodiments, k-anonymization is often described as the “hiding in the crowd” guarantee, seeking to set a threshold value (k) (e.g., k threshold) to apply to a dataset, such that there are at least k number of instances with the same set of sensitive information in order to reduce the risk of reidentification, even if there is not personally identifiable information. In certain embodiments, this is done by suppressing, which includes masking, dropping, and/or removing, specific fields that would potentially help with the reidentification of the data.

In some embodiments, the method is to protect the privacy of individuals' data in the data by ensuring there are at least k rows (e.g., k number of instances, k records, etc.) like the individual's data, while reducing (e.g., minimizing) the number of fields that need to be suppressed where each suppression reduces the utility of the dataset. In certain embodiments, the k-anonymization system is configured to conduct the suppression logic and k-checks (e.g., check how many records including same quasi-identifiers) sequentially, and suppress cells only when necessary. In some embodiments, instead of mass suppressing or removing entire columns, the k-anonymization system is configured to suppress (e.g., only suppress) one or more specific cells that need to be suppressed since there are not enough other rows to meet the k threshold.

According to some embodiments, the k-anonymization system (e.g., a K-Anonymity toolkit) operationalizes this technique by creating platform tooling within a data management software to assist with suppression workflows and/or enforce k-anonymization, for example, in a data fusion software, and/or in other software.

According to certain embodiments, the k-anonymization system is configured to do k-anonymization by first abstracting all the k-anonymization logic from the user by asking for input dataset, k-value, one or more quasi-identifiers (e.g., quasi-identifying columns), and one or more suppression order (e.g., order of the transformation steps in the data suppression strategy) and/or strategies (e.g., data suppression strategy). In some embodiments, the k-anonymization system iteratively runs through and computes a sequence of checks and suppresses only necessary cells, and writes out the final k-anonymized dataset. In some examples, the k-anonymization system outputs one or more validation datasets (e.g., a series of validation datasets) that can be used to evaluate the profile of the one or more output datasets (e.g., resulting datasets) and inspect the suppressed data. In certain examples, one or more datasets can be used for back alerting if any data rules, checks, or expectations are violated.

In some implementations, the k-anonymization system allows users to request the k-anonymization applied to their data, especially prior to publishing this data to the public or sharing with outside organizations. Some existing systems often overly suppress data (e.g., those systems drop entire rows or end up aggregating the data entirely, instead of suppressing at a more granular level).

According to some embodiments, a user can deploy the k-anonymization system for sensitive data that needs to be k-anonymized. In some embodiments, one or more users can specify the dataset, k value, one or more quasi-identifies (e.g., quasi-identifying columns), and suppression strategies. In certain embodiments, the k-anonymization system outputs the k-anonymized dataset. In some embodiments, the k-anonymization system outputs a series of validation datasets that capture the metadata and/or one or more metrics for the output k-anonymized dataset to ensure the integrity and profile, a dataset of all suppressed data and how many values were suppressed. In certain embodiments, the output of the k-anonymization system can be used for verification as well as optimization of future suppression strategies.

According to certain embodiments, the k-anonymization system can optimize k-anonymization on datasets to reduce the number of suppressed fields. In some embodiments, the k-anonymization system can be used to prepare more elaborate aggregation and suppressions on datasets. In some examples, the k-anonymization system can also be used to aggregate, suppress, or anonymize PII or any data. In certain examples, one or more metadata files and/or one or more verification files can be leveraged for other reporting and functionalities to understand the profile of the underlying data.

According to some embodiments, a k-anonymization system, also referred to as a k-anonymity, can be used as platform tooling within a data management system to assist with one or more data suppression workflows and/or to enforce k-anonymization, for example, in a data fusion software, and/or in other software.

In certain embodiments, personally identifiable information (PII) refers to information that directly links or can distinguish or trace to an individual's identity. In some examples, PII can take many forms and often defined by different data protection regulations. Examples of PII include: contact information—name, email, phone number; ID numbers—social security number (SSN), license number, medical record number, tax identification numbers (TIN); biometrics—facial signatures, images of individuals, DNA; dates—birth date, admission date, discharge date, surgery date, clinical trial dates; location information—home address, office address, wearables location data, cell phone locations; health information—past, present, or future physical or mental health or condition, medications, treatments and diagnoses; financial information—income or assets, medical bills or payments, account numbers; and other sensitive information—phone logs, IP addresses.

According to some embodiments, k-anonymization, often described as the “hiding in the crowd” guarantee, seeks to set a threshold value (k) to apply to a dataset, such that there are at least k number of instances with the same set of sensitive information in order to reduce the risk of reidentification (even if there is no personally identifiable information).

According to certain embodiments, one or more quasi-identifiers include one or more attributes that can be linked with other quasi-identifiers and/or external data to uniquely identify an individual. Examples of quasi-identifiers include, for example, demographics data (e.g., age, sex, etc.).

According to some embodiments, k, also referred to as k-value, refers to the number set in k-anonymization such that every record (e.g., every row, every instance) of the dataset (e.g., a set of records) cannot be distinguished from k-1 other records in quasi-identifiers (e.g., k records include same quasi-identifiers).

According to certain embodiments, [symbol] -diversity refers to an extension of the k-anonymity model which addressed certain weaknesses (e.g., homogeneity attacks), by ensuring intra-group diversity. In some examples, while a k-anonymity technique protects privacy by ensuring each record “looks like” at least k-1 other records, it is possible that all k records have similar (or exactly the same) one or more values for one or more sensitive attributes (e.g., quasi-identifiers), therefore limiting the usefulness of the one or more generalization and suppression strategies that were applied. In certain examples, there are multiple definitions of [symbol] -diversity for determining whether each group of records has one or more “well represented” values for the sensitive attribute, but one version (e.g., the simplest version) requires that each group has at least [symbol] distinct values for the sensitive field (e.g., sensitive attributes).

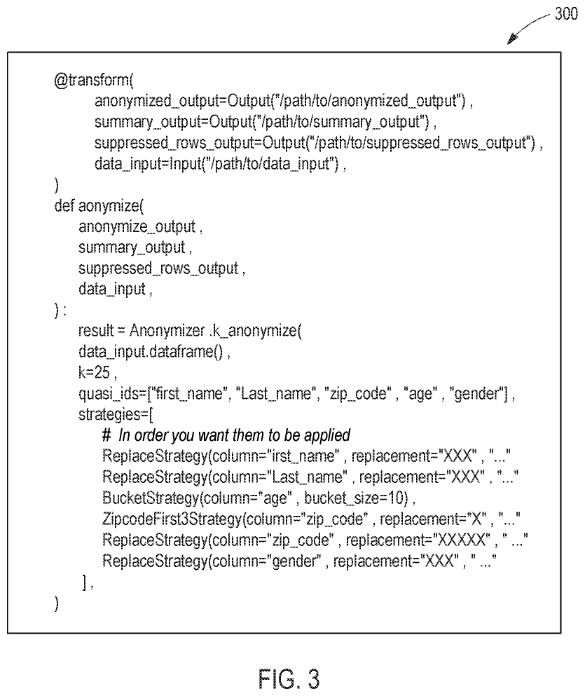

According to some embodiments, an illustrative implementation of a k-anonymization process 300 is depicted in FIG. 3. FIG. 3 is merely an example. One of ordinary skill in the art would recognize many variations, alternatives, and modifications. As illustrated, the k-anonymization process 300 includes an example data suppression strategy that includes a plurality of replacement processes, one bucketing process, and one masking processing (e.g., the zip-code masking). In this example, the k-value is set to 25. In some examples, the implementation uses any one of the embodiments described herein.

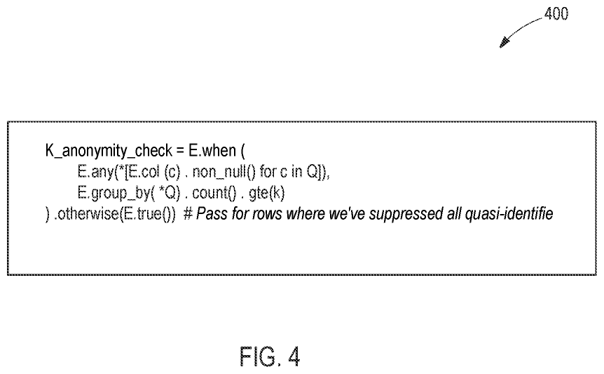

According to certain embodiments, an illustrative implementation of a k-anonymity-check process 400 is depicted in FIG. 4. FIG. 4 is merely an example. One of ordinary skill in the art would recognize many variations, alternatives, and modifications. In this example, the k-anonymity-check process 400 includes a step of grouping data records, for example, grouping data records having anonymity values less than k.

According to some embodiments, a k-anonymization system first removes one or more PII columns. In some examples, the current logic and metrics takes the input dataset as is. In certain examples, the k-anonymization system or other data management system may drop the one or more PII columns in a cleaned or upstream dataset before applying the k-anonymization transform to the dataset. In some examples, if the one or more PII columns are removed, the dataset becomes:

Input Dataset=Input Schema−[PII Columns]

Additionally, the k-anonymized dataset, or referred as suppressed data, is:

K-anonymized Dataset=only quasi-identifiers suppressed+non-quasi-identifying columns not suppressed

According to certain embodiments, a k-anonymization system may, if the one or more PII columns is desired to be kept, for example, for the dataset schema to match the original input, may treat the one or more PII columns as one or more quasi-identifiers. In some examples, if the one or more PII columns are not removed, the dataset becomes:

Input Dataset=Input Schema

Additionally, the k-anonymized dataset, or referred as suppressed data, is:

K-anonymized Dataset=all PII and quasi-identifiers suppressed+non-quasi-identifying columns not suppressed

In certain examples, the k-anonymization system allows one or more users to review the quasi-identifiers suppression output, for example, by filtering the one or more suppressions using one or more columns.

According to some embodiments, the k-anonymization system may identify and anonymize one or more low cardinality columns. In certain embodiments, for one or more columns with low cardinality, it may not be sufficient if the k-anonymization system suppresses just one value but not the others. For example, in a sex column, if you replace “MALE” with “XXX” but leave “FEMALE” as is, it can be easily inferred that “XXX” maps to “MALE”. In some embodiments, the k-anonymization system may process one or more low cardinality columns based on the one or more corresponding column patterns.

According to certain embodiments, the k-anonymization system may optimize data suppression order and strategy. In some embodiments, the k-anonymization system uses the ordering of suppressions based on input from a user. In certain embodiments, the order and data have different implications on how much of the original utility of the data is preserved. In some embodiment, the k-anonymization system can iterate and evaluate the one or more metrics of k-anonymized dataset (e.g., suppressed data) to check if different ordering and suppression strategies can reduce the total amount of data suppressed.

According to some embodiments, organizations are collecting a large number of valuable but sensitive information about individuals (e.g., patient data) to share with the public to share externally for purposes of research, public transparency, reporting, etc. In some embodiments, even after PII columns are dropped, the data can still be reidentified. In certain embodiments, a data management system can use k-anonymization techniques for deidentifying data. In some examples, the k-anonymization techniques can reduce the risk of reidentification by ensuring there are at least k records that have the same quasi-identifying columns, for example, by suppressing values (e.g., masking, replacing bucketing, etc.). In certain examples, quasi-identifying columns aren't identifying, but are fields that can be linked to other data to reidentify someone.

According to certain embodiments, k-anonymization systems and methods can anonymize the data, for example, where every data entry can then “hide in a crowd” with other data entries. In some embodiments, k-anonymization systems and methods can verify the anonymized data, for example, using k-anonymity checks.

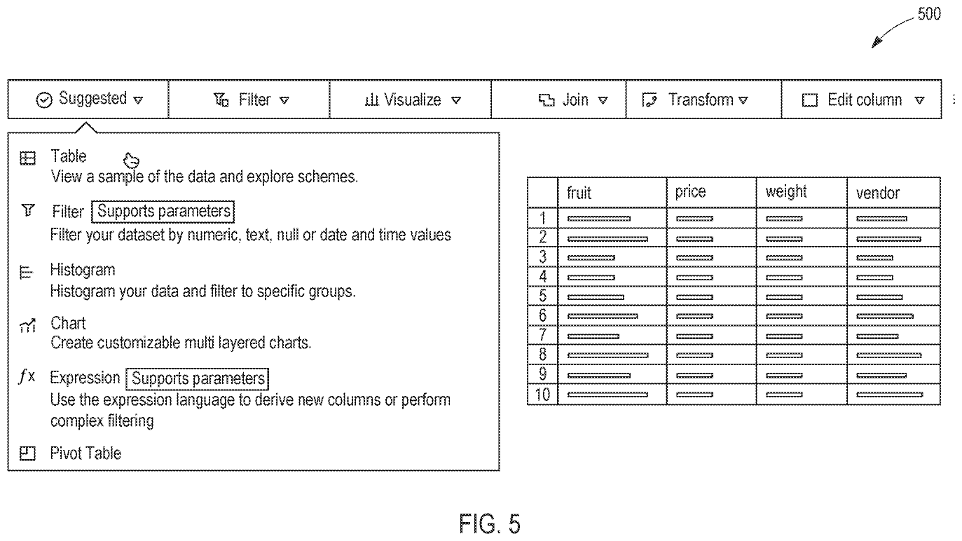

According to some embodiments, a k-anonymization system includes an anonymizer library (e.g., a reusable anonymizer library) and/or a k-anonymizer board (e.g., a user interface allowing a user to configure the k-anonymization system). In certain embodiments, the k-anonymization system includes one or more validation processes to ensure that the data is prepared (e.g., satisfied the anonymization requirement) and ready to share. According to some embodiments, an illustrative user interface 500 for a k-anonymization system is depicted in FIG. 5. FIG. 5 is merely an example. One of ordinary skill in the art would recognize many variations, alternatives, and modifications.

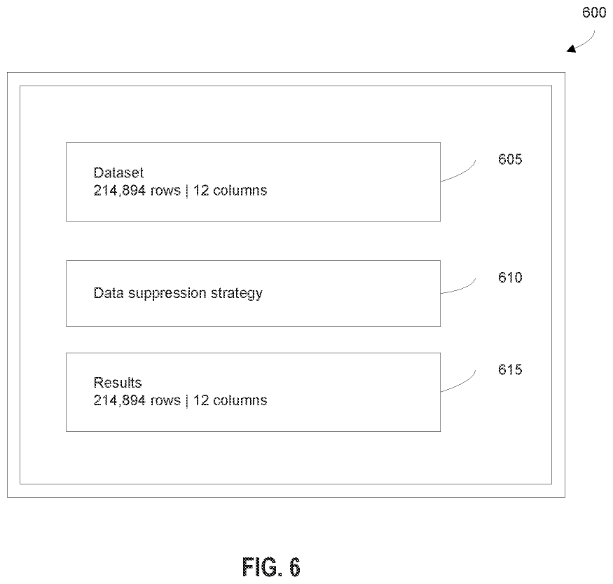

According to certain embodiments, the k-anonymization system receives a dataset including person-level data with PII and quasi-identifiers (e.g., demographics). In some embodiments, the k-anonymization system or a data management system (e.g., a data management system coupled to the k-anonymization system, a data management system including the k-anonymization system) drops the PII columns. According to some embodiments, an illustrative user interface 600 for a k-anonymization system receiving or accessing a dataset is depicted in FIG. 6. FIG. 6 is merely an example. One of ordinary skill in the art would recognize many variations, alternatives, and modifications. In this example, the example user interface 600 includes a representation of an input dataset 605, a representation of a data suppression strategy 610, and an indication of suppression results 615.

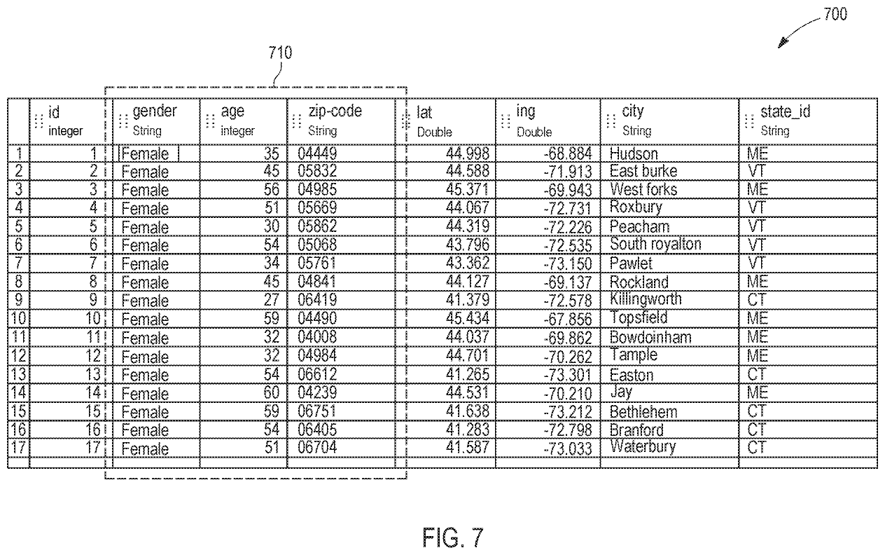

According to some embodiments, the k-anonymization system receives the quasi-identifying columns (e.g., to k-anonymize gender, age, and zip code). In some examples, the quasi-identifying columns are received from a user. According to certain embodiments, an illustrative user interface 700 for a k-anonymization system showing quasi-identifying columns (quasi-identifier data fields) 710 in a dataset is depicted in FIG. 7. FIG. 7 is merely an example. One of ordinary skill in the art would recognize many variations, alternatives, and modifications. In this example, the quasi-identifying columns 710 include a gender data fields (e.g. column), an age column, and a zip-code data field.

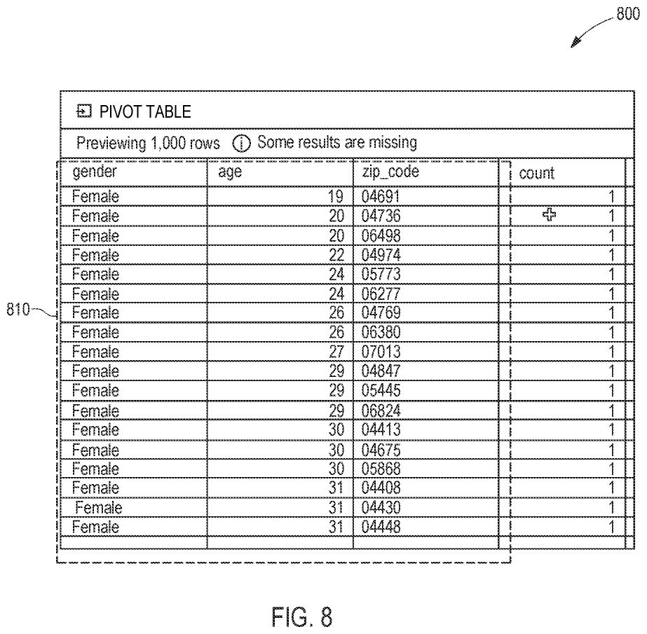

According to some embodiments, the k-anonymization system performs a k-anonymity check to see the anonymity value for each data entry or selected data entries. In some embodiments, the k-anonymization system performs the k-anonymity check by pivoting on the quasi columns. According to certain embodiments, an illustrative user interface 800 for a k-anonymization system showing quasi-identifying columns 810 in a dataset is depicted in FIG. 8. FIG. 8 is merely an example. One of ordinary skill in the art would recognize many variations, alternatives, and modifications. In the example, a k-anonymity check has been conducted and an anonymity value for each data record is shown in column 820. As an example, the anonymity value is 1, which indicates the data entry to be re-identifiable (e.g., highly re-identifiable).

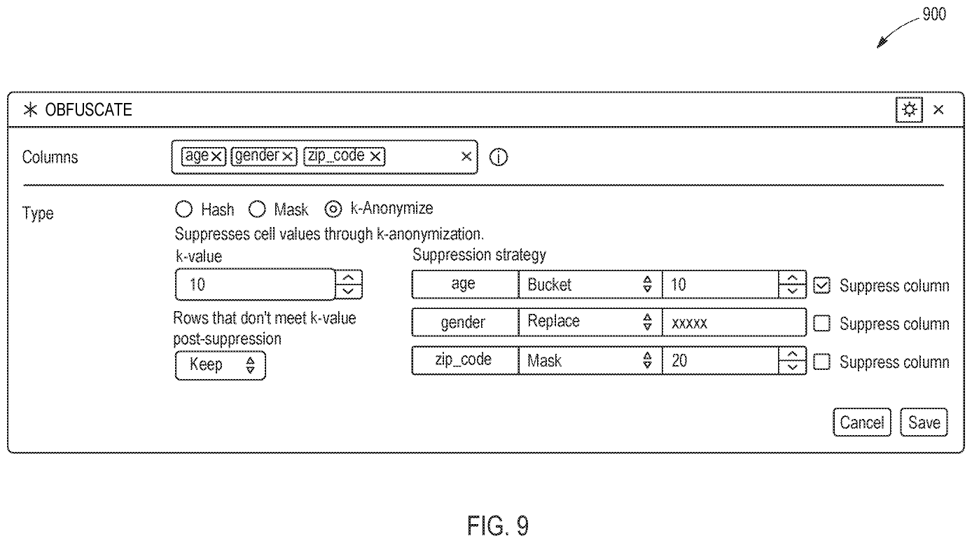

According to some embodiments, an illustrative user interface 900 (e.g., an obfuscate board) for a k-anonymization system is depicted in FIG. 9. FIG. 9 is merely an example. One of ordinary skill in the art would recognize many variations, alternatives, and modifications. In certain embodiments, a user can specify target k-value, select one or more quasi-identifying columns in a dataset, provide the order of the one or more quasi-identifying columns, and/or provide the one or more data suppression strategies (e.g., one or more data transformation steps).

In some embodiments, a user can provide the one or more quasi-identifying columns, for example, via the user interface as illustrated in FIG. 8. In certain examples, a user can set the target k-value (e.g., 10). In some embodiments, a user can provide the one or more data suppression strategies. In certain embodiments, a user may specify an order of processing the one or more quasi-identifying columns. In some embodiments, a user may specify the suppression approach (e.g., bucket, replace, mask, etc.) for a corresponding quasi-identifying column. For example, a user may specify a bucketing transform, e.g., bucketing the age with a unit of 10 (e.g., an age of 21 being set to “20-29”, an age of 15 being set to “10-19”). As an example, a user may specify a replacing transform, e.g., replacing gender with “XXXXX”. For example, a user may specify a mask transform, e.g., masking 2 digits of zip code.

According to certain embodiments, the k-anonymization system activates the anonymization process, for example, based on the set k-value, the one or more quasi-identifying columns, and how to suppress those one or more quasi-identifying columns such as replacing values, bucketing ages, etc. In some embodiments, the k-anonymization system applies a first suppression transform to all data entries in the input dataset. In certain embodiments, the k-anonymization system applies a first suppression transform (e.g., bucketing ages, etc.) to a part of data entries in the input dataset, where each data entry of the data entries has an anonymity value lower than the target k-value. In one example, the k-anonymization system can use bucketed ages, replaced genders, and edited zip codes to anonymize data. In some embodiments, the k-anonymization system performs k-anonymity check to the data entries to which the first suppression transform performed. In certain embodiments, the k-anonymization system applies a subsequent suppression transform all data entries in the dataset. In certain embodiments, the k-anonymization system applies a subsequent suppression transform (e.g., replacing genders, masking zip codes, etc.) to all data entries in the dataset. In some embodiments, the k-anonymization system applies a subsequent suppression transform (e.g., replacing genders, masking zip codes, etc.) to a part of or all the data entries in the dataset, where each data entry of the data entries has an anonymity value lower than the target k-value.

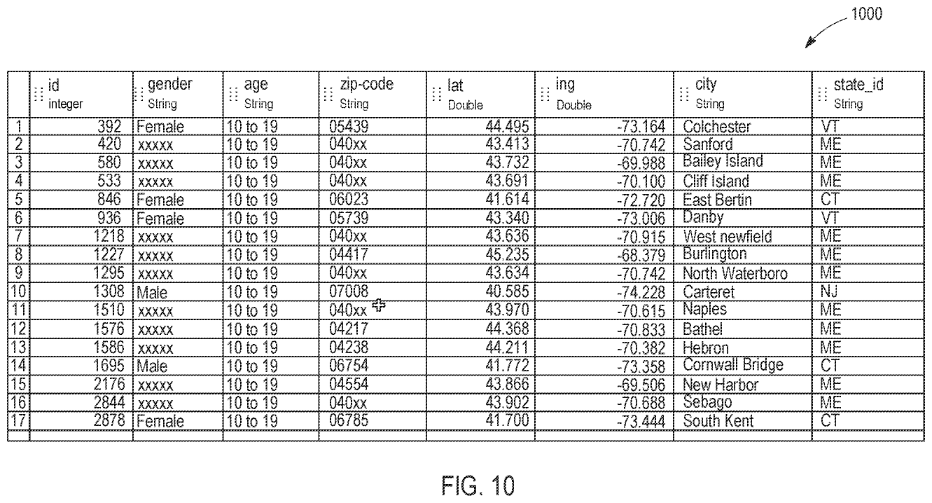

According to some embodiments, the k-anonymization system generates outputs. In certain embodiments, the outputs include a k-anonymized dataset. According to certain embodiments, an illustrative example 1000 of a k-anonymized dataset is shown in FIG. 10. FIG. 10 is merely an example. One of ordinary skill in the art would recognize many variations, alternatives, and modifications. In some embodiments, a subset of data records in the suppressed dataset are generated using a gender suppression process (e.g., masking the gender data as “xxxxx”). In certain embodiments, the gender suppression process is applied to a subset of the input dataset. In some embodiments, a subset of data records in the suppressed dataset are generated using a zip-code masking process (e.g., masking the last two digits of a zip-code, masking the last two digits of the zip-code as “xx”). In certain embodiments, the zip-code masking process is applied to a subset of the input dataset.

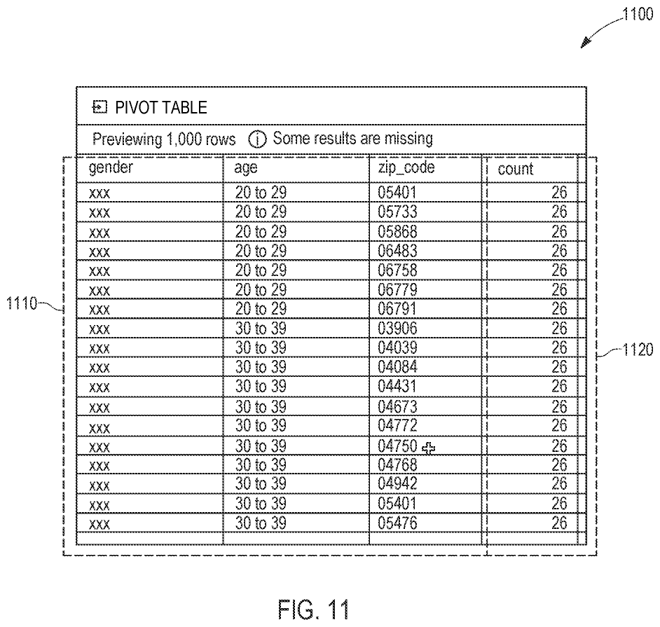

According to some embodiments, an illustrative example of a k-anonymized dataset 1100 and corresponding anonymity values 1120 are shown in FIG. 11. FIG. 11 is merely an example. One of ordinary skill in the art would recognize many variations, alternatives, and modifications. As an example, the quasi-identifiers columns 1110 include suppressed data (e.g., bucketed data, replaced data, etc.). As illustrated, in one example, each data entry has an anonymity value of 26, which is higher than a target k-value of 10 and a target k-value of 25.

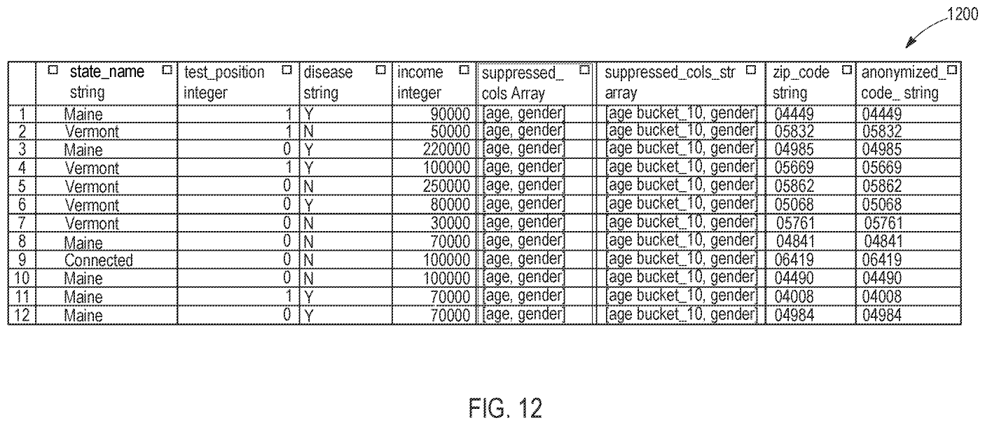

According to certain embodiments, the outputs generated by the k-anonymization system include a verification set of suppressed data (e.g., suppressed rows, suppressed dataset). In some examples, the verification set of suppressed data include the raw data and the suppressed data. According to certain embodiments, an illustrative example of a verification set of suppressed data 1200 is shown in FIG. 12. FIG. 12 is merely an example. One of ordinary skill in the art would recognize many variations, alternatives, and modifications. In some examples, the verification set of suppressed data 1200 includes metadata indicating the one or more quasi-identifiers 1210 used in suppression. In certain examples, the verification set of suppressed data 1200 includes an indication of data suppression strategy 1220.

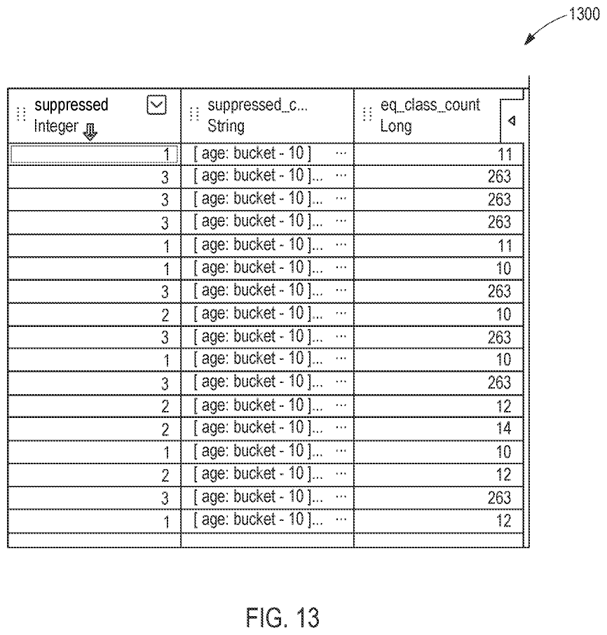

In some embodiments, the k-anonymization system adds metadata to the suppressed data. According to certain embodiments, an illustrative example of metadata 1300 is shown in FIG. 13. FIG. 13 is merely an example. In some examples, the metadata 1300 includes metadata of one data column. In certain examples, the metadata 1300 includes metadata of two or more data columns.

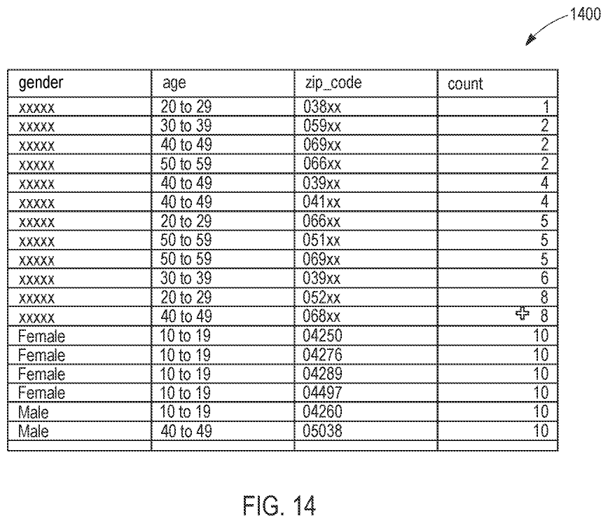

In some embodiments, the k-anonymization system may generate an anonymized dataset with some data entries having anonymity values lower than the target k-value (e.g., 10) and some data entries having anonymity values equal to or higher than the target k-value. In some examples, the fully suppressed data based on suppression strategies, but some rows still do not reach the target k-value (e.g., k=10). According to certain embodiments, an illustrative example of an anonymized dataset (e.g., a suppressed dataset) 1400 is shown in FIG. 14. FIG. 14 is merely an example. One of ordinary skill in the art would recognize many variations, alternatives, and modifications. As illustrated in FIG. 14, there are nine (9) data entries having anonymity values lower than the target k-value (e.g., k=10).

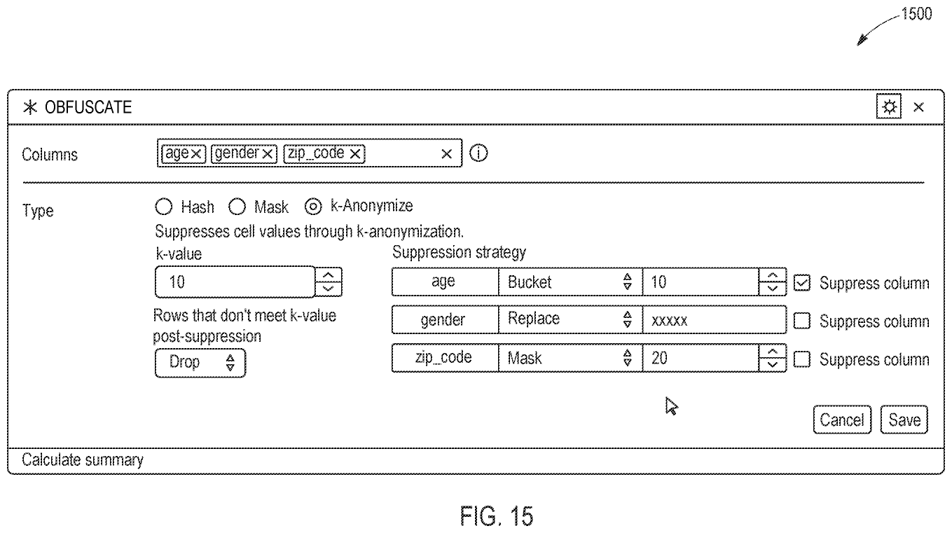

According to some embodiments, the k-anonymization system can receive one or more inputs and/or one or more configurations on how to process the data records of the suppressed data that have anonymity values lower than the target k-value. According to certain embodiments, an illustrative example of a user interface 1500 allowing a user to specify a data suppression strategy (e.g., how to process specific data fields) is shown in FIG. 15. FIG. 15 is merely an example. One of ordinary skill in the art would recognize many variations, alternatives, and modifications. As illustrated, a user may specify to drop data entries with anonymity values lower than the target k-value after the suppression process. In some embodiments, the system presents the one or more quasi-identifiers on a user interface. In certain embodiments, the system is configured to receive one or more suppression inputs (e.g., one or more parameters associated with one or more transformation steps) associated with the one or more quasi-identifiers. In some embodiments, the system is configured to compile the one or more transformation steps based on the one or more data suppression inputs and the one or more quasi-identifier; and generate the data suppression strategy using the one or more transformation steps. In certain embodiments, the one or more suppression inputs (e.g., suppression parameters) include a bucket size for a bucket process, a masking parameter for a masking parameter, whether the transformation applies to only data entries having anonymity values lower than a target value, whether to suppress (e.g., remove) data entries having anonymity values lower than a target value, and/or the like.

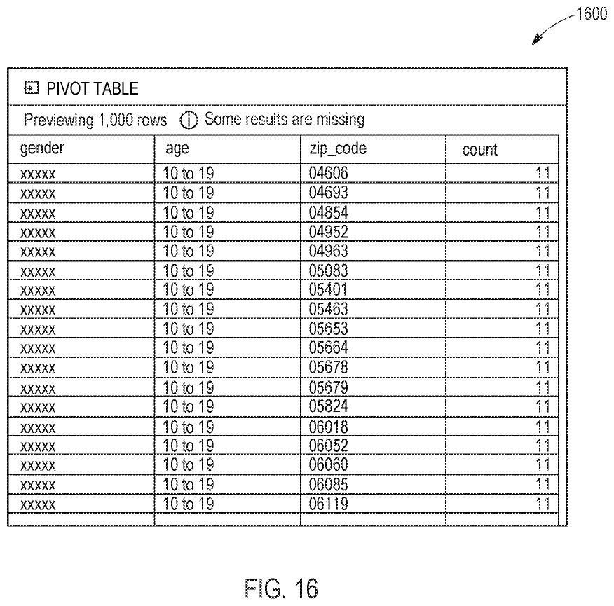

According to some embodiments, an illustrative example of the resulting dataset 1600 (e.g., the suppressed dataset) after the configuration in FIG. 15 is shown in FIG. 16. FIG. 16 is merely an example. One of ordinary skill in the art would recognize many variations, alternatives, and modifications. As illustrated, in certain examples, data entries having anonymity values greater than the target k-value are suppressed (e.g., dropped). In some examples, the suppressed dataset includes only data entries having anonymity values equal to or greater than the target k-value (e.g., k=10).

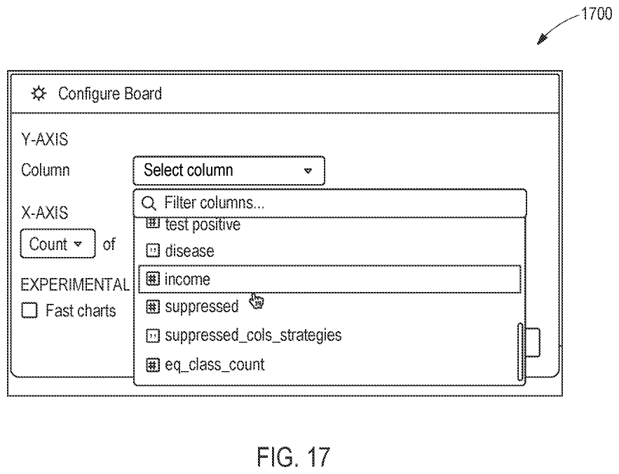

According to certain embodiments, the outputs include a summary (e.g., summary statistics) of input data and/or suppressed data, and/or one or more column metrics. In some embodiments, the k-anonymization system can evaluate one or more suppressed columns (e.g., patterns of suppressed columns) to optimize the data suppression order (e.g., in a different order). In some embodiments, the k-anonymity system checks if the data profile changed much with the metrics from the input dataset. According to certain embodiments, an illustrative example of a user interface 1700 allowing an inspection of suppression strategies for optimizations on suppression order and/or strategies is shown in FIG. 17. FIG. 17 is merely an example. One of ordinary skill in the art would recognize many variations, alternatives, and modifications.

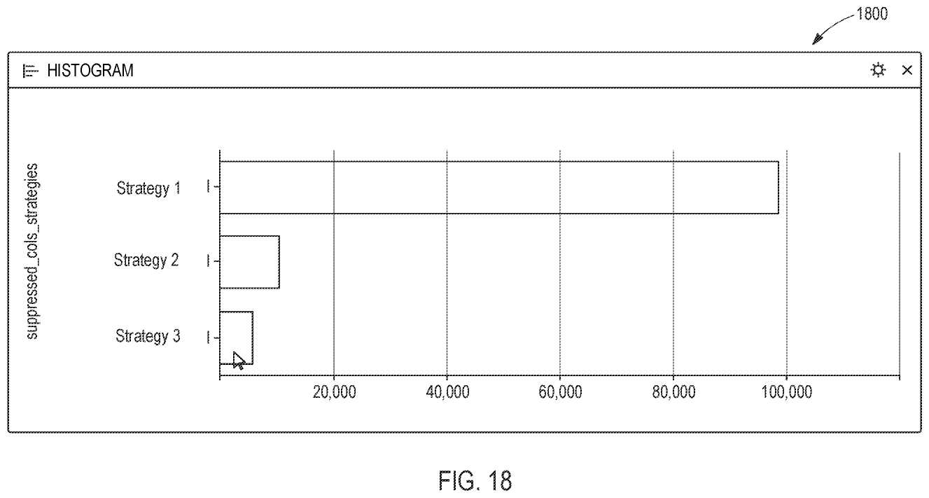

According to some embodiments, an illustrative example of a statistics summary 1800 (e.g., histogram) of the suppressed data for an inspection of suppression strategies for optimizations on suppression order and/or strategies is shown in FIG. 18. FIG. 18 is merely an example. One of ordinary skill in the art would recognize many variations, alternatives, and modifications. In certain examples, the statistics summary can compare performance of different strategies. In some examples, the performance is better for a strategy causing less suppressed data entries. In one example, the histogram indicates the number of suppressed data entries. For example, the Strategy 2 in FIG. 18 is better than the Strategy 1 as the Strategy 2 requires less suppressed data entries to meet the target k-value.

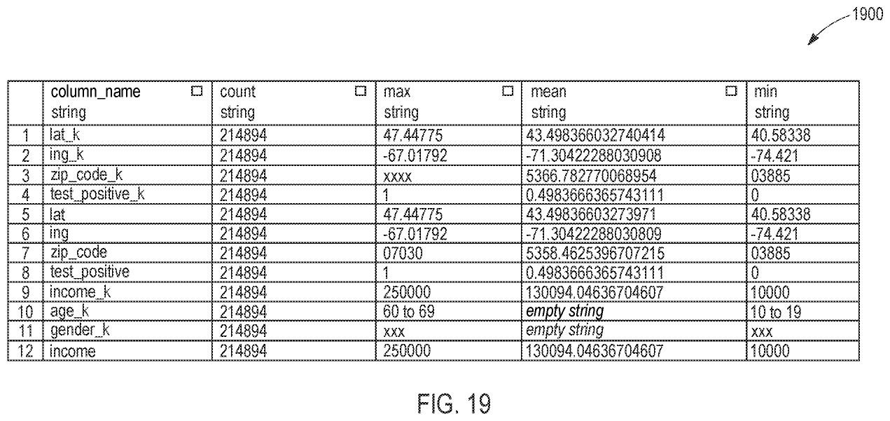

According to certain embodiments, an illustrative example of a statistics summary 1900 of the suppressed data for an inspection of suppression strategies for optimizations on suppression order and/or strategies is shown in FIG. 19. FIG. 19 is merely an example. One of ordinary skill in the art would recognize many variations, alternatives, and modifications. In some embodiments, the statistics summary 1900 includes data statistics for data columns (e.g., data fields).

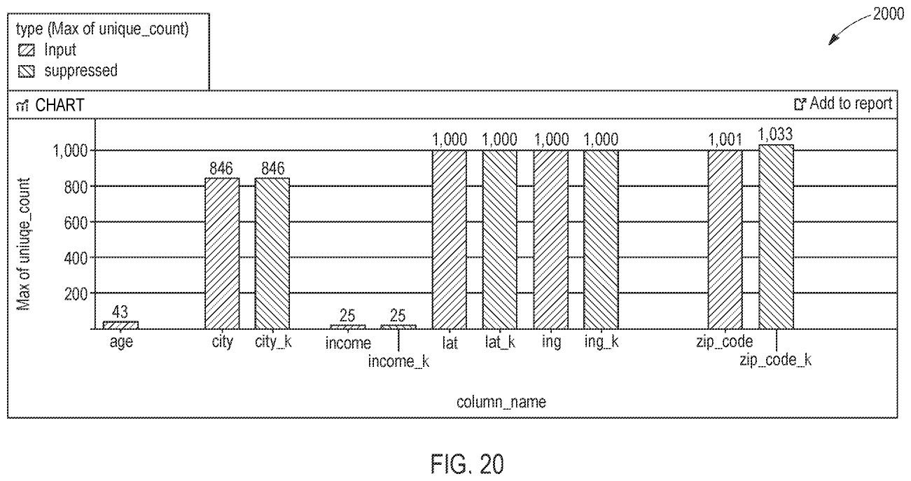

According to some embodiments, an illustrative example of a statistics summary 2000 (e.g., histogram on unique counts) of the suppressed data for an inspection of suppression strategies for optimizations on suppression order and/or strategies is shown in FIG. 20. FIG. 20 is merely an example. One of ordinary skill in the art would recognize many variations, alternatives, and modifications. In the example illustrated, the input dataset and the suppressed data are compared side by side. In some examples, the suppressed data (e.g., dataset after being suppressed) has largely the same unique counts as the input data for a number of data columns. In certain embodiments, this can be used to confirm how much of the dataset has been altered and whether it can still be used for analysis. In some embodiments, this is done by confirming the data still represents a similar distribution and profile similar to before it was suppressed.

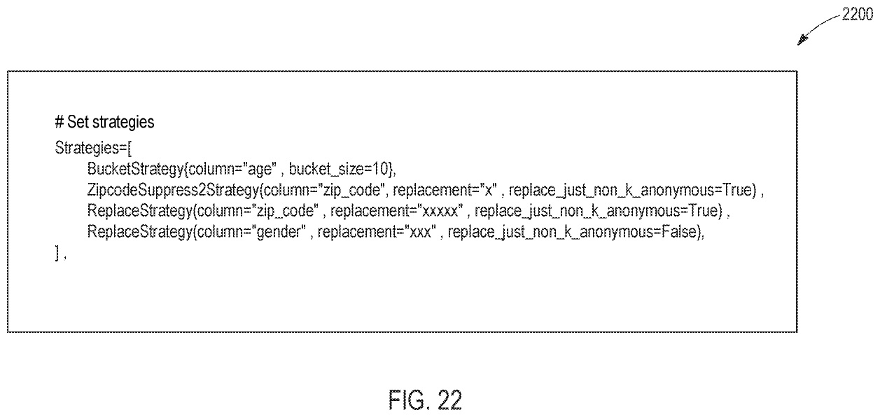

According to certain embodiments, an illustrative implementation 2100 of a k-anonymization system is illustrated in FIG. 21. FIG. 21 is merely an example. One of ordinary skill in the art would recognize many variations, alternatives, and modifications. In some examples, the implementation 2100 includes one or more transformation steps to be applied to only data entries having anonymity values less that the target k-value. In certain examples, the implementation 2100 includes one or more transformation steps to be applied to all data entries in the input dataset.

According to some embodiments, a k-anonymization system can perform a plurality of suppression processes (e.g., transformation processes, transformation steps), each of the plurality of suppression processes is associated with a respective data suppression order and/or strategies. For example, a first data suppression strategy includes age buckets with 5 increments (e.g., 10-14, 15-19, 20-24, 25-29, etc.) and a second data suppression strategy includes age buckets with 10 increments (e.g., 10-19, 20-29, etc.). As an example, a first data suppression order is to perform age bucketing before zip-code masking, and the second data suppression order is to perform zip-code masking before age bucketing. For example, a first data suppression strategy includes the zip-code masking of the last two digits and a second data suppression strategy includes the zip-code masking of the last three digits.

In certain embodiments, the k-anonymization system can perform the plurality of suppression processes to one or more input datasets to generate a plurality of suppression datasets and based on the plurality of suppression datasets, optimize the suppression processes including the associated suppression orders and/or strategies. In some embodiments, the k-anonymization system inspects the plurality of suppression datasets using one or more inspection parameters. In some examples, the one or more inspection parameters include the number of rows being suppressed, the number of data cells being suppressed, the number of columns suppressed or masked, the number of rows dropped (e.g., removed from the suppressed dataset), the degree of generalization (e.g., the bucket size, bucket of 5, bucket of 10), the number of columns being removed, 1-diversity parameter, and/or other inspection parameters. As an example, 150,000 data cells are suppressed when the k-anonymization system uses a first data suppression order (e.g., age bucketing before zip-code masking) and 143,000 data cells are suppressed when the k-anonymization system uses a second data suppression order (e.g., zip-code masking before age bucketing).

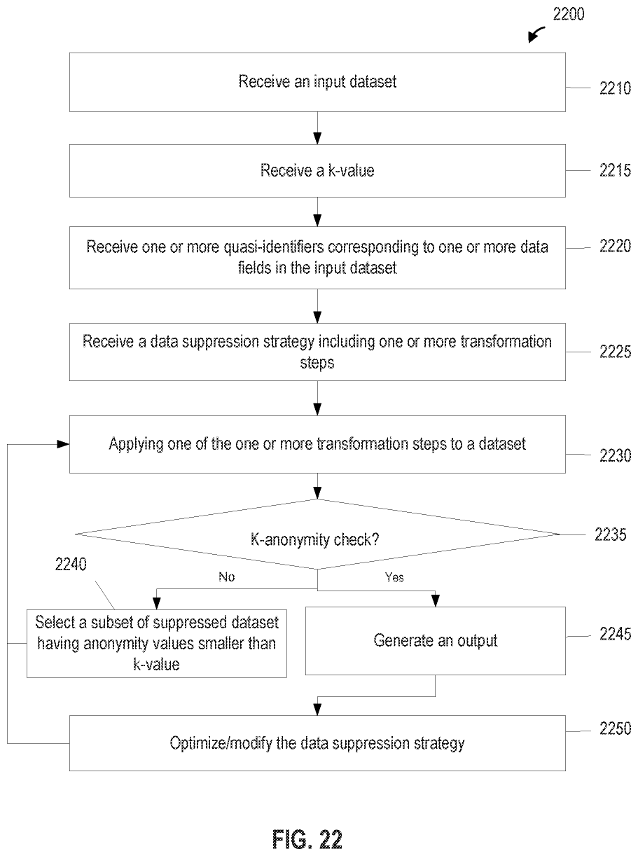

FIG. 22 is a simplified diagram showing a method 2200 for k-anonymization and optimization according to certain embodiments of the present disclosure. This diagram is merely an example. One of ordinary skill in the art would recognize many variations, alternatives, and modifications. The method 200 for k-anonymization and optimization includes processes 2210, 2215, 2220, 2225, 2230, 2235, 2240, 2245 and 2250. Although the above has been shown using a selected group of processes for the method 2200 for k-anonymization and verification, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present disclosure.

In some embodiments, some or all processes (e.g., steps) of the method 2200 are performed by a system (e.g., the computing system 2300). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 2200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at the process 2210, the computing system is configured to receive an input dataset. In certain examples, the input dataset is submitted by and/or received from a user. In some examples, the input dataset is received via a software interface (e.g., application programming interface, web service, etc.) from a computing device and/or a processing system. In certain examples, the input dataset is retrieved from a data repository (e.g., a database, a data file, a data stream, etc.).

According to certain embodiments, at the process 2215, the system is configured to receive the target k-value (e.g., k=10, k=25), for example, to protect sensitive information. In some embodiments, at the process 2220, the system is configured to receive one or more quasi-identifiers (e.g., demographic data, one or more quasi-identifier columns, one or more quasi-identifier data fields, sensitive attributes, etc.) corresponding to one or more data fields in the input dataset.

According to some embodiments, the system is configured to receive a data suppression strategy including one or more transformation steps. In some examples, the data suppression strategy includes suppression transforms (e.g., masking, bucketing, replacing, etc.) for corresponding data columns. In certain examples, the data suppression strategy includes one or more transformation steps, where each transformation step is applied to a specific column or data element. For example, the data suppression strategy includes replacing gender, bucketing ages, and masking zip-code. In certain examples, the data suppression strategy is submitted by and/or received from a user. In some examples, the data suppression strategy is received via a software interface (e.g., application programming interface, web service, etc.) from a computing device and/or a processing system. In certain examples, the data suppression strategy is retrieved from a data repository (e.g., a database, a data file, a configuration file, etc.). In some examples, the system is configured to generate the data suppression strategy based at least in part on the one or more received quasi-identifiers. In certain examples, the system is configured to generate at least one transformation step based at least in part on the one or more received quasi-identifiers.

According to certain embodiments, the data suppression strategy includes an order of the one or more transformation steps. In some embodiments, the data suppression strategy includes one or more parameters (e.g., order, constraints, etc.) associated with the data suppression strategy. In certain embodiments, the data suppression strategy includes one or more parameters (e.g., bucket size, masking parameters, etc.) associated with the one or more transformation steps of the data suppression strategy.

According to some embodiments, at the process 2230, the system is configured to apply one of the one or more transformation steps to a dataset (e.g., the input dataset, a subsequent input dataset, a subset of a suppressed dataset) to generate a suppressed dataset. For example, the one or more transformation steps include a bucketing process to bucket ages by 10, a replacement process to replace genders by “XXXXX”, and a masking step to mask a portion of zip codes.

According to certain embodiments, at the process 2235, the system is configured to conduct k-anonymity check to the suppressed dataset (e.g., an output dataset). In some embodiments, the system is configured to conduct k-anonymity check to the suppressed dataset after every transformation step in the data suppression strategy. In certain embodiments, the k-anonymity check includes checking data entries' corresponding anonymity values. In some embodiments, the k-anonymity check includes determining a record anonymity value for each data record of a plurality of data records in the suppressed dataset.

According to some embodiments, if the k-anonymity check is not met, at the process 2240, the system is configured to select a subset of the suppressed dataset having anonymity values lower than the k-value. In certain embodiments, the k-anonymity check is not met if a subset of the suppressed dataset has anonymity value lower than the k-value. In some embodiments, the system goes back to the process 2230 to anonymize at least the selected subset of the suppressed dataset (e.g., the entire suppressed dataset, the subset having anonymity value lower than the k-value) by conducting a next transformation step according to the data suppression strategy. In certain embodiments, the system is configured to apply the one or more transformation steps according to an order. In some embodiments, the one or more transformation steps include a step to remove (e.g., suppress) data entries that have anonymity values lower than the k-value.

According to some embodiments, the k-anonymity check is met if each data record in the suppressed dataset has anonymity value equal to or greater than the k-value. In certain embodiments, if the k-anonymity check is met, at the process 2245, the system is configured to generate an output (e.g., the k-anonymized output). In certain embodiments, the k-anonymized output includes the suppressed dataset. In some embodiments, the k-anonymized output includes a summary. In certain embodiments, the k-anonymized output includes the input dataset (e.g., raw data) and suppressed dataset for verification. In some embodiments, the k-anonymized output includes a statistics summary (e.g., an example summary shown in FIG. 18).

According to certain embodiments, at the process 2250, the system is configured to optimize and/or modify the data suppression strategy. In some embodiments, the data suppression strategy is associated with a suppression metric. In certain embodiments, a suppression metric includes the number of data fields being suppressed and/or the number of data entries being suppressed. In some embodiments, a suppression metric includes a 1-diversity value. In certain embodiments, the system is configured to optimize the data suppression strategy based at least in part on the suppression metric.

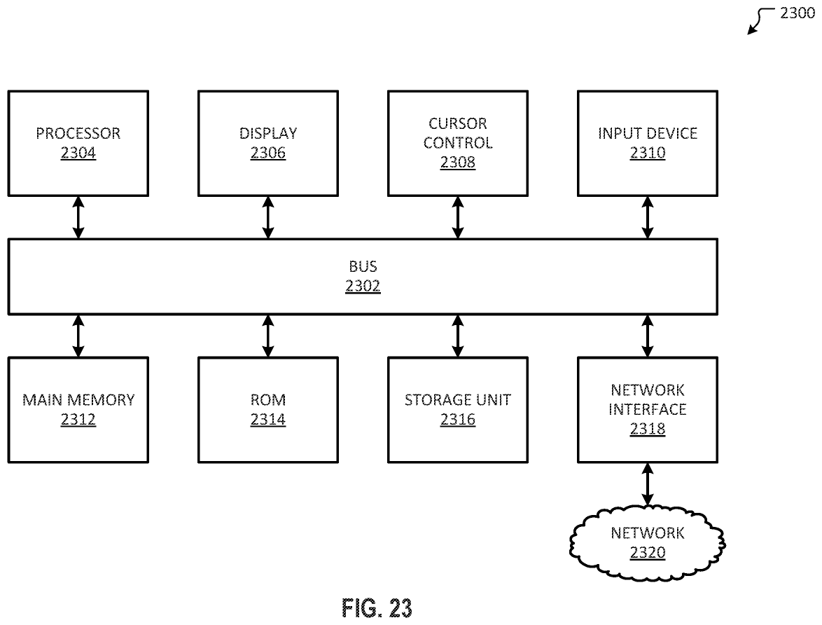

FIG. 23 is a simplified diagram showing a computing system for implementing a system 2300 for k-anonymization and verification in accordance with at least one example set forth in the disclosure. This diagram is merely an example, which should not unduly limit the scope of the claims. One of ordinary skill in the art would recognize many variations, alternatives, and modifications.

The computing system 2300 includes a bus 2302 or other communication mechanism for communicating information, a processor 2304, a display 2306, a cursor control component 2308, an input device 2310, a main memory 2312, a read only memory (ROM) 2314, a storage unit 2316, and a network interface 2318. In some embodiments, some or all processes (e.g., steps) of the methods 100, 200 and/or 2200 are performed by the computing system 2300. In some examples, the bus 2302 is coupled to the processor 2304, the display 2306, the cursor control component 2308, the input device 2310, the main memory 2312, the read only memory (ROM) 2314, the storage unit 2316, and/or the network interface 2318. In certain examples, the network interface is coupled to a network 2320. For example, the processor 2304 includes one or more general purpose microprocessors. In some examples, the main memory 2312 (e.g., random access memory (RAM), cache and/or other dynamic storage devices) is configured to store information and instructions to be executed by the processor 2304. In certain examples, the main memory 2312 is configured to store temporary variables or other intermediate information during execution of instructions to be executed by processor 2304. For examples, the instructions, when stored in the storage unit 2316 accessible to processor 2304, render the computing system 2300 into a special-purpose machine that is customized to perform the operations specified in the instructions. In some examples, the ROM 2314 is configured to store static information and instructions for the processor 2304. In certain examples, the storage unit 2316 (e.g., a magnetic disk, optical disk, or flash drive) is configured to store information and instructions.

In some embodiments, the display 2306 (e.g., a cathode ray tube (CRT), an LCD display, or a touch screen) is configured to display information to a user of the computing system 2300. In some examples, the input device 2310 (e.g., alphanumeric and other keys) is configured to communicate information and commands to the processor 2304. For example, the cursor control component 2308 (e.g., a mouse, a trackball, or cursor direction keys) is configured to communicate additional information and commands (e.g., to control cursor movements on the display 2306) to the processor 2304.

According to certain embodiments, a method for k-anonymization, the method comprising: receiving an input dataset; receiving a k-value, the k-value being a positive integer; receiving one or more quasi-identifiers corresponding to one or more data fields in the input dataset; receiving a data suppression strategy including one or more transformation steps, at least one transformation step of the one or more transformation steps associated with at least one quasi-identifier of one or more one or more quasi-identifiers; applying a first transformation step of the one or more transformation steps to at least one data field of the one or more data fields in the input dataset to generate a suppressed dataset including at least one suppressed data field corresponding to the at least one data field; checking an anonymity value of each data record of a plurality of data records in the suppressed dataset; selecting a subset of the suppressed dataset from the suppressed dataset, one or more data records in the selected subset of the suppressed dataset each has a corresponding anonymity value lower than the k-value; and applying a second transformation step of the one or more transformation steps to at least the subset of the suppressed dataset to generate an output, the second transformation step being different from the first transformation step; wherein the method is performed using one or more processors. For example, the method is implemented according to at least FIG. 1, FIG. 2, and/or FIG. 22.

In some embodiments, the checking an anonymity value of the suppressed dataset comprises determining a record anonymity value for each data record of a plurality of data records in the suppressed dataset. In certain embodiments, the anonymity value is a first anonymity value and the suppressed dataset is a first suppressed dataset, wherein the applying a second transformation step comprises generating a second suppressed dataset by applying the second transformation step to at least the subset of the first suppressed dataset, wherein the method further comprises: checking a second anonymity value of the second suppressed dataset; selecting a subset of the second suppressed dataset from the second suppressed dataset, one or more data records in the selected subset of the second suppressed dataset each has a corresponding anonymity value lower than the k-value; and applying a third transformation step of the one or more transformation steps to at least the subset of the second suppressed dataset to generate the output, the third transformation step being different from the second transformation step, the third transformation step being different from the first transformation step. In some embodiments, the first transformation step applies to a first quasi-identifier and the second transformation step applies to a second quasi-identifier, wherein the first quasi-identifier is different from the second quasi-identifier.

In certain embodiments, the one or more transformation steps includes at least one selected from a group consisting of masking, bucketing, and replacing. In some embodiments, the receiving a data suppression strategy comprises: presenting the one or more quasi-identifiers on a user interface; receiving one or more suppression inputs associated with the one or more quasi-identifiers; compiling the one or more transformation steps based on the one or more data suppression inputs and the one or more quasi-identifier; and generating the data suppression strategy using the one or more transformation steps. In some embodiments, at least one suppression input of the one or more suppression inputs includes a selection of a transformation type and a value associated with the selected transformation type. In certain embodiments, the data suppression strategy includes an order of the one or more transformation steps, wherein a first transformation step of the one or more transformation steps is applied before a second transformation step of the one or more transformation steps according to the order.

In some embodiments, the data suppression strategy is applied to a first subset of the one or more quasi-identifiers, wherein the method further comprises: modifying the data suppression strategy by changing the order of the one or more transformation steps; wherein the first transformation step of the one or more transformation steps is applied after the second transformation step. In certain embodiments, the modified data suppression strategy is applied to a second subset of the one or more quasi-identifiers to generate a second suppressed dataset such that the second suppressed dataset has an anonymity value not lower than the k-value; wherein the second subset of the one or more quasi-identifiers includes a second number of quasi-identifiers less than a first number of quasi-identifiers in the first subset of the one or more quasi-identifiers. In some embodiments, the data suppression strategy includes a process of bucketing to group data into a plurality of first buckets associated with a first bucket size, where the method further comprises: modifying the data suppression strategy by changing the process of bucketing to group data into a plurality of second buckets associated with a second bucket size smaller than the first bucket size.

In certain embodiments, the data suppression strategy is a first data expression strategy, where the method further comprises: determining a first suppression metric associated with the first data expression strategy; modifying a parameter associated with one transformation step of the one or more transformation steps of the first data suppression strategy to generate a second data suppression strategy; determining a second suppression metric associated with the second data expression strategy; and selecting a data suppression strategy from the first data suppression strategy and the second data suppression strategy based on the first suppression metric and the second suppression metric. In some embodiments, the output includes an output dataset, wherein the output dataset includes data from the input dataset and data from the suppressed dataset.

According to some embodiments, a method for k-anonymization, the method comprising: receiving an input dataset receiving a k-value, the k-value being a positive integer; receiving one or more quasi-identifiers; receiving a data suppression strategy including one or more transformation steps, at least one transformation step of the one or more transformation steps associated with at least one quasi-identifier of one or more one or more quasi-identifiers, one transformation step of the one or more transformation steps configured to suppress one or more cells selected from a plurality of cells for a data field in the input dataset, the one or more selected cells being a subset of the plurality of cells; and applying the one or more transformation steps to the input dataset to generate a suppressed dataset such that the suppressed dataset has an anonymity value not lower than the k-value; wherein the method is performed using one or more processors. For example, the method is implemented according to at least FIG. 1, FIG. 2, and/or FIG. 22.

According to certain embodiments, a system for k-anonymization, the system comprising: one or more memories comprising instructions stored thereon; and one or more processors configured to execute the instructions and perform operations comprising: receiving an input dataset; receiving a k-value, the k-value being a positive integer; receiving one or more quasi-identifiers corresponding to one or more data fields in the input dataset; receiving a data suppression strategy including one or more transformation steps, at least one transformation step of the one or more transformation steps associated with at least one quasi-identifier of one or more one or more quasi-identifiers; and applying a first transformation step of the one or more transformation steps to at least one data field of the one or more data fields in the input dataset to generate a suppressed dataset including at least one suppressed data field corresponding to the at least one data field; checking an anonymity value of each data record of a plurality of data records in the suppressed dataset; selecting a subset of the suppressed dataset from the suppressed dataset, one or more data records in the selected subset of the suppressed dataset each has a corresponding anonymity value lower than the k-value; and applying a second transformation step of the one or more transformation steps to at least the subset of the suppressed dataset to generate an output, the second transformation step being different from the first transformation step. For example, the system is implemented according to at least FIG. 1, FIG. 2, and/or FIG. 22.

In some embodiments, the checking an anonymity value of the suppressed dataset comprises determining a record anonymity value for each data record of a plurality of data records in the suppressed dataset. In certain embodiments, the anonymity value is a first anonymity value and the suppressed dataset is a first suppressed dataset, wherein the applying a second transformation step comprises generating a second suppressed dataset by applying the second transformation step to at least the subset of the first suppressed dataset, wherein the operations include: checking a second anonymity value of the second suppressed dataset; selecting a subset of the second suppressed dataset from the second suppressed dataset, one or more data records in the selected subset of the second suppressed dataset each has a corresponding anonymity value lower than the k-value; and applying a third transformation step of the one or more transformation steps to at least the subset of the second suppressed dataset to generate the output, the third transformation step being different from the second transformation step, the third transformation step being different from the first transformation step. In some embodiments, the first transformation step applies to a first quasi-identifier and the second transformation step applies to a second quasi-identifier, wherein the first quasi-identifier is different from the second quasi-identifier.

In certain embodiments, the one or more transformation steps includes at least one selected from a group consisting of masking, bucketing, and replacing. In some embodiments, the receiving a data suppression strategy comprises: presenting the one or more quasi-identifiers on a user interface; receiving one or more suppression inputs associated with the one or more quasi-identifiers; compiling the one or more transformation steps based on the one or more data suppression inputs and the one or more quasi-identifier; and generating the data suppression strategy using the one or more transformation steps. In some embodiments, at least one suppression input of the one or more suppression inputs includes a selection of a transformation type and a value associated with the selected transformation type. In certain embodiments, the data suppression strategy includes an order of the one or more transformation steps, wherein a first transformation step of the one or more transformation steps is applied before a second transformation step of the one or more transformation steps according to the order.

In some embodiments, the data suppression strategy is applied to a first subset of the one or more quasi-identifiers, wherein the operations include: modifying the data suppression strategy by changing the order of the one or more transformation steps; wherein the first transformation step of the one or more transformation steps is applied after the second transformation step. In certain embodiments, the modified data suppression strategy is applied to a second subset of the one or more quasi-identifiers to generate a second suppressed dataset such that the second suppressed dataset has an anonymity value not lower than the k-value; wherein the second subset of the one or more quasi-identifiers includes a second number of quasi-identifiers less than a first number of quasi-identifiers in the first subset of the one or more quasi-identifiers. In some embodiments, the data suppression strategy includes a process of bucketing to group data into a plurality of first buckets associated with a first bucket size, where the operations include: modifying the data suppression strategy by changing the process of bucketing to group data into a plurality of second buckets associated with a second bucket size smaller than the first bucket size.

In certain embodiments, the data suppression strategy is a first data expression strategy, where the operations include: determining a first suppression metric associated with the first data expression strategy; modifying a parameter associated with one transformation step of the one or more transformation steps of the first data suppression strategy to generate a second data suppression strategy; determining a second suppression metric associated with the second data expression strategy; and selecting a data suppression strategy from the first data suppression strategy and the second data suppression strategy based on the first suppression metric and the second suppression metric. In some embodiments, the output includes an output dataset, wherein the output dataset includes data from the input dataset and data from the suppressed dataset.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for k-anonymization, the method comprising:
receiving an input dataset;
receiving a k-value, the k-value being a positive integer;
receiving one or more quasi-identifiers corresponding to one or more data fields in the input dataset;
receiving a data suppression strategy including one or more transformation steps, at least one transformation step of the one or more transformation steps associated with at least one quasi-identifier of one or more one or more quasi-identifiers;
applying a first transformation step of the one or more transformation steps to at least one data field of the one or more data fields in the input dataset to generate a suppressed dataset including at least one suppressed data field corresponding to the at least one data field;
checking an anonymity value of each data record of a plurality of data records in the suppressed dataset;
selecting a subset of the suppressed dataset from the suppressed dataset, one or more data records in the selected subset of the suppressed dataset each has a corresponding anonymity value lower than the k-value; and
applying a second transformation step of the one or more transformation steps to at least the subset of the suppressed dataset to generate an output, the second transformation step being different from the first transformation step;
wherein the method is performed using one or more processors.

2. The method of claim 1, wherein the checking an anonymity value of the suppressed dataset comprises determining a record anonymity value for each data record of a plurality of data records in the suppressed dataset.

3. The method of claim 1, wherein the anonymity value is a first anonymity value and the suppressed dataset is a first suppressed dataset, wherein the applying a second transformation step comprises generating a second suppressed dataset by applying the second transformation step to at least the subset of the first suppressed dataset, wherein the method further comprises:
checking a second anonymity value of the second suppressed dataset;
selecting a subset of the second suppressed dataset from the second suppressed dataset, one or more data records in the selected subset of the second suppressed dataset each has a corresponding anonymity value lower than the k-value; and
applying a third transformation step of the one or more transformation steps to at least the subset of the second suppressed dataset to generate the output, the third transformation step being different from the second transformation step, the third transformation step being different from the first transformation step.

4. The method of claim 1, wherein the first transformation step applies to a first quasi-identifier and the second transformation step applies to a second quasi-identifier, wherein the first quasi-identifier is different from the second quasi-identifier.

5. The method of claim 1, wherein the one or more transformation steps includes at least one selected from a group consisting of masking, bucketing, and replacing.

6. The method of claim 1, wherein the receiving a data suppression strategy comprises:
presenting the one or more quasi-identifiers on a user interface;
receiving one or more suppression inputs associated with the one or more quasi-identifiers;
compiling the one or more transformation steps based on the one or more data suppression inputs and the one or more quasi-identifier; and
generating the data suppression strategy using the one or more transformation steps.

7. The method of claim 6, wherein at least one suppression input of the one or more suppression inputs includes a selection of a transformation type and a value associated with the selected transformation type.

8. The method of claim 1, wherein the data suppression strategy includes an order of the one or more transformation steps, wherein a first transformation step of the one or more transformation steps is applied before a second transformation step of the one or more transformation steps according to the order.

9. The method of claim 8, wherein the data suppression strategy is applied to a first subset of the one or more quasi-identifiers, wherein the method further comprises:
modifying the data suppression strategy by changing the order of the one or more transformation steps;
wherein the first transformation step of the one or more transformation steps is applied after the second transformation step.

10. The method of claim 9, wherein the modified data suppression strategy is applied to a second subset of the one or more quasi-identifiers to generate a second suppressed dataset such that the second suppressed dataset has an anonymity value not lower than the k-value;
wherein the second subset of the one or more quasi-identifiers includes a second number of quasi-identifiers less than a first number of quasi-identifiers in the first subset of the one or more quasi-identifiers.

11. The method of claim 1, wherein the data suppression strategy includes a process of bucketing to group data into a plurality of first buckets associated with a first bucket size, wherein the method further comprises:
modifying the data suppression strategy by changing the process of bucketing to group data into a plurality of second buckets associated with a second bucket size smaller than the first bucket size.

12. The method of claim 1, wherein the data suppression strategy is a first data expression strategy, wherein the method further comprises:
determining a first suppression metric associated with the first data expression strategy;
modifying a parameter associated with one transformation step of the one or more transformation steps of the first data suppression strategy to generate a second data suppression strategy;
determining a second suppression metric associated with the second data expression strategy; and
selecting a data suppression strategy from the first data suppression strategy and the second data suppression strategy based on the first suppression metric and the second suppression metric.

13. The method of claim 1, wherein the output includes an output dataset, wherein the output dataset includes data from the input dataset and data from the suppressed dataset.

14. A method for k-anonymization, the method comprising:
receiving an input dataset;
receiving a k-value, the k-value being a positive integer;
receiving one or more quasi-identifiers;
receiving a data suppression strategy including one or more transformation steps, at least one transformation step of the one or more transformation steps associated with at least one quasi-identifier of one or more one or more quasi-identifiers, one transformation step of the one or more transformation steps configured to suppress one or more cells selected from a plurality of cells for a data field in the input dataset, the one or more selected cells being a subset of the plurality of cells; and
applying the one or more transformation steps to the input dataset to generate a suppressed dataset such that the suppressed dataset has an anonymity value not lower than the k-value;
wherein the method is performed using one or more processors.

15. A system for k-anonymization, the system comprising:
one or more memories comprising instructions stored thereon; and
one or more processors configured to execute the instructions and perform operations comprising:
receiving an input dataset;
receiving a k-value, the k-value being a positive integer;
receiving one or more quasi-identifiers corresponding to one or more data fields in the input dataset;
receiving a data suppression strategy including one or more transformation steps, at least one transformation step of the one or more transformation steps associated with at least one quasi-identifier of one or more one or more quasi-identifiers; and
applying a first transformation step of the one or more transformation steps to at least one data field of the one or more data fields in the input dataset to generate a suppressed dataset including at least one suppressed data field corresponding to the at least one data field;
checking an anonymity value of each data record of a plurality of data records in the suppressed dataset;
selecting a subset of the suppressed dataset from the suppressed dataset, one or more data records in the selected subset of the suppressed dataset each has a corresponding anonymity value lower than the k-value; and
applying a second transformation step of the one or more transformation steps to at least the subset of the suppressed dataset to generate an output, the second transformation step being different from the first transformation step.

16. The system of claim 15, wherein the checking an anonymity value of the suppressed dataset comprises determining a record anonymity value for each data record of a plurality of data records in the suppressed dataset.

17. The system of claim 15, wherein the anonymity value is a first anonymity value and the suppressed dataset is a first suppressed dataset, wherein the applying a second transformation step comprises generating a second suppressed dataset by applying the second transformation step to at least the subset of the first suppressed dataset, wherein the operations further comprise:
checking a second anonymity value of the second suppressed dataset;
selecting a subset of the second suppressed dataset from the second suppressed dataset, one or more data records in the selected subset of the second suppressed dataset each has a corresponding anonymity value lower than the k-value; and
applying a third transformation step of the one or more transformation steps to at least the subset of the second suppressed dataset to generate the output, the third transformation step being different from the second transformation step, the third transformation step being different from the first transformation step.

18. The system of claim 15, wherein the first transformation step applies to a first quasi-identifier and the second transformation step applies to a second quasi-identifier, wherein the first quasi-identifier is different from the second quasi-identifier.

19. The system of claim 15, wherein the one or more transformation steps includes at least one selected from a group consisting of masking, bucketing, and replacing.

20. The system of claim 15, wherein the receiving a data suppression strategy comprises:
presenting the one or more quasi-identifiers on a user interface;
receiving one or more suppression inputs associated with the one or more quasi-identifiers;
compiling the one or more transformation steps based on the one or more data suppression inputs and the one or more quasi-identifier; and
generating the data suppression strategy using the one or more transformation steps.
